(19) United States
(12) Patent Application Publication
(10) Pub. No.: US 2025/0307323 A1
(43) Pub. Date: Oct. 2, 2025

(54) Premium User-Managed Multi-Media Format Hashtag Aggregation on Digital Websites and Platforms

(71) Applicant: Gan Jing World Corporation, Middletown, NY (US)

(72) Inventors: Terry Wu, Middletown, NY (US); Tao Yin, Middletown, NY (US)

(21) Appl. No.: 18/618,310

(22) Filed: Mar. 27, 2024

(51) Int. Cl. G06F 16/953

(52) U.S. Cl. CPC G06F 16/953

(57) ABSTRACT

A system for curating and aggregating digital content is described. Content is received from a first user. The content is curated into a database indexed by hashtags. Upon receiving a request from a second user for a particular hashtag, all content indexed by the particular hashtag is collected from the database and a listing the content collected is displayed on an aggregation webpage.

### (1) TECHNICAL FIELD

The disclosure relates to aggregating digital content, and more particularly, to curating and aggregating digital content in various formats.

### (2) BACKGROUND

An aggregation of digital content is the collection of related items of content so that they can be displayed or linked to. One way to aggregate digital content is by hashtag. Hashtag aggregation pages of current social and video platforms are limited to one or two content types (e.g. Instagram: photos and videos; YouTube, Tiktok: Videos and shorts). No platform has yet provided an effective and aesthetically appealing aggregation for creators' and users' content in various formats under a single hashtag aggregation page. These content types include long and short form videos, articles, posts, photos, and more.

The lack of comprehensive hashtag aggregation across all content types creates several disadvantages and problems, including:
Limited content variety;
Fragmented user experience: Users need to switch between different tabs or platforms to consume or contribute various types of content;
Reduced discoverability: this hinders the ability to explore different media formats and a wider range of creators;
Limited collaborative opportunities due to the segmented nature of content aggregation;
Visual inconsistencies.

Secondly, current social and video platforms also do not allow users of any type to manage, edit, rank, and hide content based on the content popularity and relevance.

Several references disclose curating and/or aggregating systems including US Patent Applications 2023/0222152 (King) and 2023/0224301 (Soon-Shiong et al).

### SUMMARY

A primary objective of the present disclosure is to provide a system for curating and aggregating content in a variety of media formats.

A further objective of the present disclosure is to provide a system for curating content in a variety of media formats and to provide an effective and aesthetically appealing aggregation of content in various formats under a single hashtag aggregation page.

Another objective is to provide for administrative access of such content aggregations for premium users so that users can manage content to best suit their needs and best present content to audiences to watch and browse.

In accordance with the objectives of the present disclosure, a system for curating and aggregating content in a variety of media formats is achieved. Content is received from a first user. The content is curated into a database indexed by hashtags. Upon receiving a request from a second user for a particular hashtag, all content indexed by the particular hashtag is collected from the database and a listing of the content collected is displayed on an aggregation webpage.

Also in accordance with the objectives of the present disclosure, a non-tangible computer readable storage medium having instructions that when executed by a processor cause the processor to perform operations is achieved. The instructions comprise receiving content uploaded by a first user and curating the content into a database indexed by hashtags. Upon receiving a request from a second user for a particular hashtag, collecting all content from the database indexed by the particular hashtag and displaying a listing of the content on an aggregation webpage.

Also in accordance with the objective of the present disclosure, a method for curating and aggregating digital content is achieved. Content uploaded by a first user is received wherein the content includes one or more hashtags and a content type. The content is curated into a database wherein the curating comprises breaking down the one or more hashtags received with the content into word parts, creating one or more tags based on the word parts and associating the tags with the content, storing the content in the database indexed by the one or more hashtags wherein the tags and content type are stored along with the content, and thereafter using an algorithm to determine a weight for the content and sorting the database according to the weight. Upon receiving a request from a second user for a particular hashtag, collecting content from the database indexed by the particular hashtag wherein the collecting content comprises for each hashtag entered, retrieving all content from the database indexed by the hashtag and in order as they have been sorted into the database. A display layout is designed by categorizing contents of varying dimensions and formats into distinct groups based on predefined page sizes and preparing a listing of the contents interleaving them in an alternating arrangement and displaying a listing of the content on an aggregation webpage.

### BRIEF DESCRIPTION OF THE DRAWINGS

In the accompanying drawings forming a material part of this description, there is shown:

FIG. 1 is a block diagram of an example of a computer system in the present disclosure.

FIG. 2 is a block diagram of one example of a cloud computing environment in a preferred embodiment of the present disclosure.

FIG. 3 is a block diagram of a preferred embodiment of the software system of the present disclosure.

FIG. 4 is a flowchart of a preferred embodiment of the Curation portion of the software system of the present disclosure.

FIG. 5 is a flowchart of step 403 of FIG. 5 in a preferred embodiment of the Curation portion of the software system of the present disclosure.

FIG. 6 is a flowchart of a preferred embodiment of the Aggregation portion of the software system of the present disclosure.

FIG. 7 illustrates a sample aggregation page generated by the software system of the present disclosure.

### DETAILED DESCRIPTION

The present disclosure curates and aggregates various media formats under the same hashtag in one organized and nicely flowing aggregation page. This innovation brings together different forms of media, including long and short-form videos, articles, posts, photos, podcasts, and more.

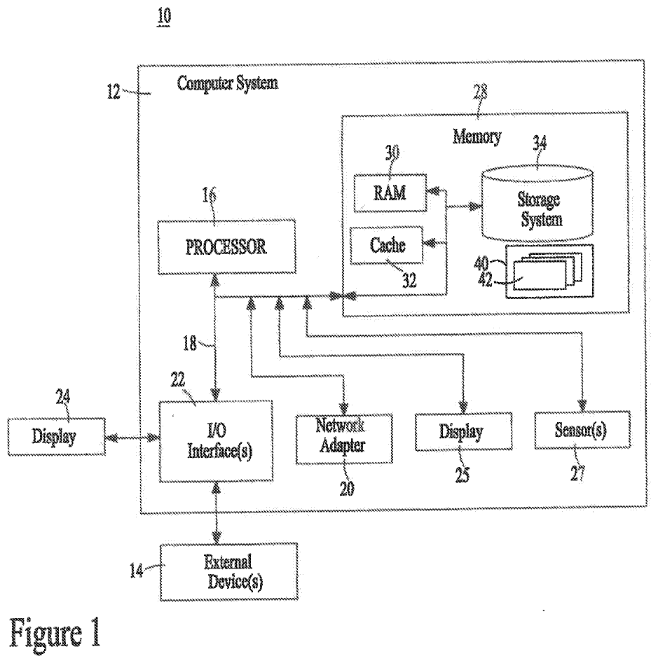

Referring now more particularly to FIG. 1, there is shown an example of a computer system 12 in a computing node 10. Computing node 10 is a computing node of a cloud computing environment or a non-cloud computing environment. Computer system 12 may include one or more processors 16, a system memory 28, and bus 18 that couples system components including system memory 28 to processor 16. System memory 28 may include any kind of computer system readable memory, such as random access memory (RAM) 30 and/or cache memory 32. Storage system 34 can be any kind of removable or non-removable memory system. One or more programs 40 having a set of program processes 42 may be stored in memory 28. Computer system 12 may communicate with one or more external devices 14 such as a keyboard, display 24, and so on. One or more network adaptors 20 may be provided to communicate with the Internet, for example. Sensor devices, such as a camera or other devices may also be provided. The computer system may be on a physical computing machine or on a cloud-based platform.

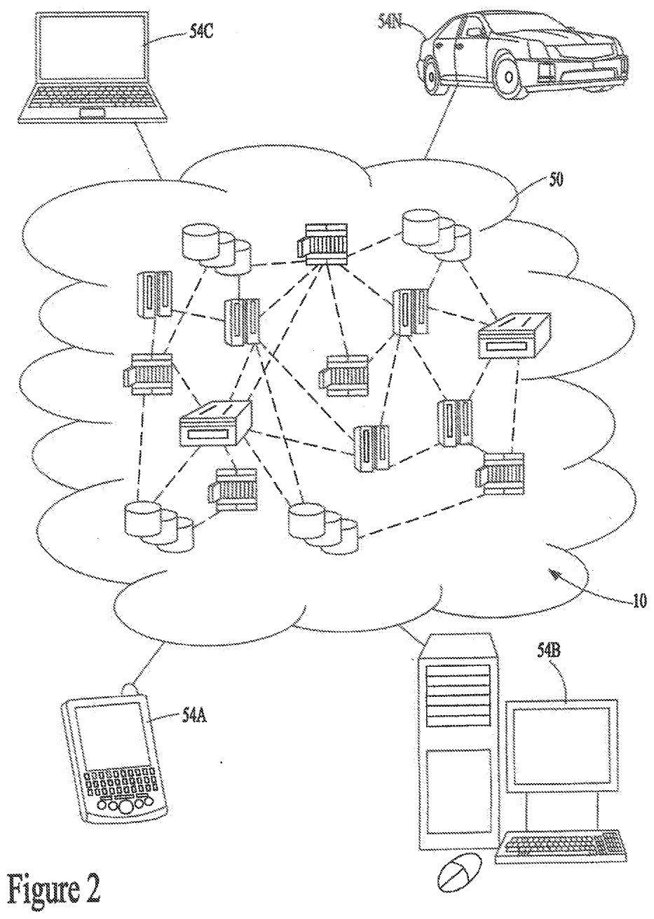

FIG. 2 shows a cloud computing environment 50. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

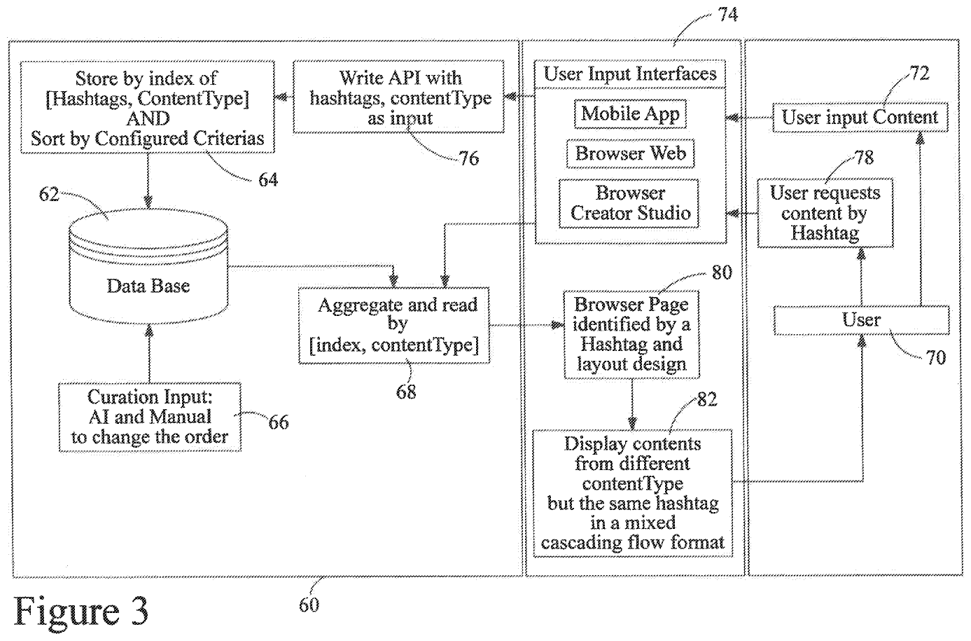

FIG. 3 illustrates an overview of a preferred embodiment of the Curation and Aggregation Software System of the present disclosure that might be on a computer system such as shown in FIG. 1 in a computing environment such as shown in FIG. 2. The disclosed Curation and Aggregation software would typically run on one or more nodes 10 in a computing environment 50, accessed by a user from a local computing device such as shown in FIG. 2.

The Curation and Aggregation software system 60 receives as input through an Application Program Interface (API) 76 any content 72 from a user 70, provided as text, a video, an audio file, a photograph, a post, or other content. The content is stored in an internal database 62. Upon a request 78 from a user 70, the Curation and Aggregation software system 60 will aggregate 68 the requested content, create a browser page 80 and display the contents 82 to the user 70 in a cascading flow format. A cascading flow format is a way of displaying content, typically used in web pages or applications, where content is presented in a continuous waterfall-like pattern, with one item following another. The Curation and Aggregation software system 60 presents the requested content to the user in this manner, meaning that the content is continuously displayed to the user in a fluid fashion, either from top to bottom or from left to right, without the need for pagination or being displayed across multiple screens. This format is often used to showcase a large amount of continuous content, allowing users to scroll continuously to browse through it.

User input is through one of several user interfaces 74 including a Mobile App, a Browser Web, or a Browser Creator Studio, for example. These user interfaces will provide input through an API 76 as input to the Curation and Aggregation Software System 60.

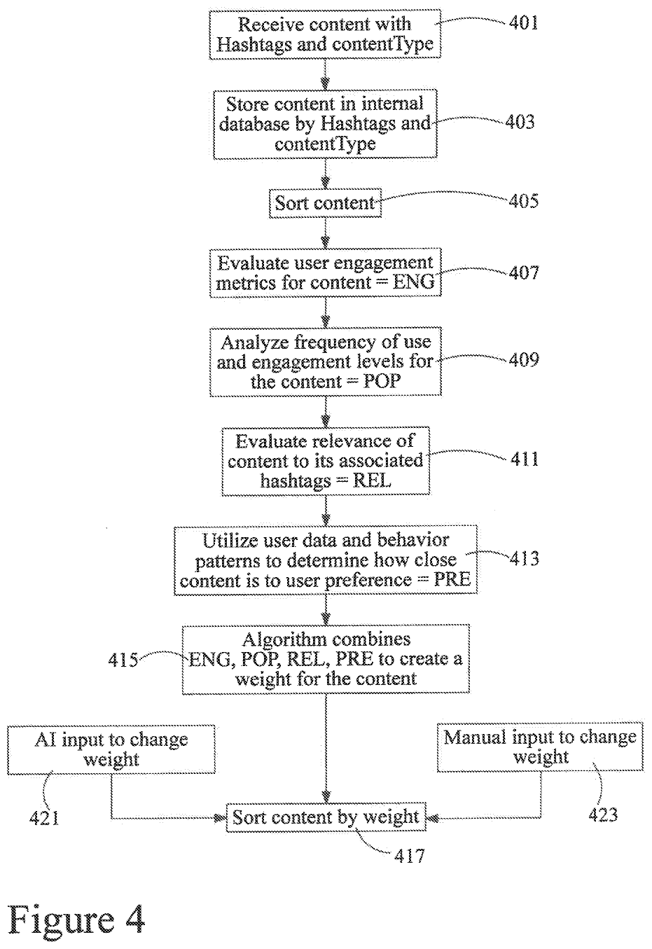

Referring now more particularly to the flowchart in FIG. 4, the Curation portion 64 of the software system will be described. In step 401, content is received from a user, including one or more hashtags and content type. In step 403, the Curation portion 64 of the software system stores the content 72 in an internal database 62.

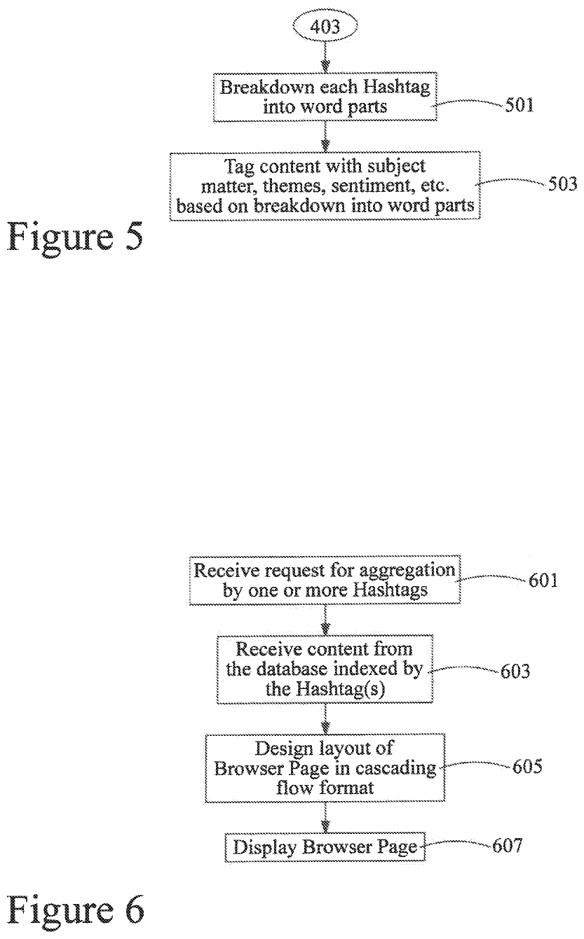

FIG. 5 illustrates further elements of step 403. Multi-layered hashtag analysis is performed on all content as it is entered. In step 501, each hashtag is broken down into word parts to extract topics, sentiments, and entities from the hashtag. These extractions are used to create additional tags dealing with subject matter, themes, sentiments, and so on, in step 503, that are stored with the content in the database 62 to assist with future search requests. Content is indexed by its hashtags and also stored with its content type and the additional tags generated in step 503.

Returning to FIG. 4, the system uses an algorithm that meticulously considers various factors to sort the content 405. Each time new content is entered, the entire database is weighted and sorted. The following weighting steps can be performed in any order that is determined to be preferable.

Step 407 User Interaction: This facet of the algorithm takes into account user engagement metrics, such as likes, comments, shares, and views, to gauge the relevance and popularity of content. Content with higher user interaction metrics is given precedence in the curation process. The user engagement metrics include engagement by the entering user as well as any other users of the software system. An engagement value ENG is determined by this section of the algorithm.

Step 409 Hashtag Weighting by Popularity: The algorithm assesses the popularity of hashtags by analyzing their frequency of use and engagement levels. Hashtags that are trending or widely used are assigned higher weights, influencing the content selection process. A popularity weight POP is calculated by this section of the algorithm.

Step 411 Content Relevance to Hashtags: Content is evaluated based on its relevance to the associated hashtags. The algorithm employs natural language processing techniques to determine how closely the content aligns with the hashtags it is tagged with. Content that aligns more closely with relevant hashtags is favored and a relevance score of REL is determined.

Step 413 User Interests: The algorithm takes into consideration the individual interests and preferences of users. It utilizes user data and behavior patterns to identify content that aligns with the entering user's specific interests. Content matching these interests is prioritized in the curation process and given a reference weight of PRE.

By weighing these factors in step 415, the algorithm ensures that the curated content is not only popular but also relevant to users' interests and the hashtags associated with it. This holistic approach results in a more personalized and engaging user experience. A final weighted score is calculated based on the scores ENG, POP, REL, and PRE. Other scoring systems might also be added to the algorithm.

Curation input 66 in FIG. 3 includes an optional manual input 423 to change the weight. Typically, manual input to give the final sorting weight will be limited by the amount of manpower available. For those contents without manual input, an artificial intelligence (AI) model 421 will be trained based on all existing manual input and then applied to give a weight to determine the final sorting weight for the content. Manual input can override the AI input as needed.

The database 62 is sorted in step 417 based on the weight determined in step 415 with optional manual 423 and/or AI 421 input for new content 72. By systematically implementing these steps, the algorithm facilitates the tagging of content and evaluates its content score. Curation is accomplished by storing submitted content in various formats, including videos, short videos (vertical), articles, posts, photos, and podcasts all associated with a specific hashtag. This content is then indexed using the hashtag as a key for subsequent sorting and retrieval operations (Aggregation) to be presented on one landing page.

FIG. 6 is a flowchart of the Aggregation portion 68 of the software system of the present disclosure. In Step 601, a user enters a request for aggregation by providing a hashtag or more than one hashtag. The hashtag is the key for retrieving all content associated with that hashtag from the internal database 62. Users can conveniently explore and find diverse content and creators across multiple media formats. Users and creators are provided with a comprehensive media aggregation experience. Users can broaden their views by consuming and engaging with different media formats within a single page and single platform, eliminating the need to switch between multiple tabs or platforms for various content types.

In Step 603, the Aggregation software 68 retrieves content from the database 62, indexed by the entered hashtag(s). Along with the content, the software retrieves the content type, the weighted score, and other tags associated with each content retrieved.

Each hashtag page aggregates content that is associated with a specific hashtag, regardless of how many hashtags are attached to that content. The system checks if the content includes the requested hashtag, and if so, it is displayed on that hashtag page. Each hashtag page is associated with only one specific hashtag. Tags are primarily used to assist with searching. When users search using a tag as a search term, hashtag pages containing that tag are prioritized in the search results.

In Step 605, the aggregation page layout is designed 80 to be a visually appealing presentation, aiming to provide an immersive and visually captivating experience for users. The formatting process 80 involves categorizing contents of varying dimensions and formats into distinct groups based on predefined page sizes and subsequently interleaving them in an alternating arrangement. In Step 607, the aggregation is displayed 82 on a single landing page that is arranged in such a way that contents of different heights and formats are inserted alternatively such that even in the initial view of the feed flow at the top of the page, the contents are not aligned in order to provide the user with visual interest and stimulation. Sorted order is based on the content first and for each content type, the content is sorted and ranked based on the sorting algorithm. The ranked content types are alternatively interleaved to display the ranked content in their own content type positions on the page.

If more than one hashtag is requested, each hashtag will have its own landing page. The fact that each hashtag possesses its own page indicates that users not only can quickly find pages related to a specific tag or keyword but also can explore the collection of content under each particular hashtag in more detail. This design aids users in efficiently organizing and accessing information through hashtags, enhancing search relevance and user experience. Overall, this search mechanism allows users to navigate directly to pages related to relevant hashtags through tags or keywords, distinguishing them from other types of content such as videos, articles, and channels, enabling users to delve deeper into specific topics or discussions based on their interests.

Using an automatic layout approach, the software system can achieve a visually appealing layout simply by determining the height of each block while the rest is done by the browser itself. The software system determines the width and height of each block of the content as well as a linear position of all contents put in an array. The software also determines the number of columns to display in the browser based on its current window width. Then, the browser itself will put the contents into the layout in an up-to-down, then left-tot-right order based on the next available spots in the layout.

Based on the given width of the display area, the software system can determine the content and single column width, as well as the number of columns. It can calculate the precise render height of the content prior to rendering. It then converts this pixel height to a span height that the grid css display mode, for example, can interpret. This value is applied to the end position of each element prior to rendering so that the proper height will be rendered.

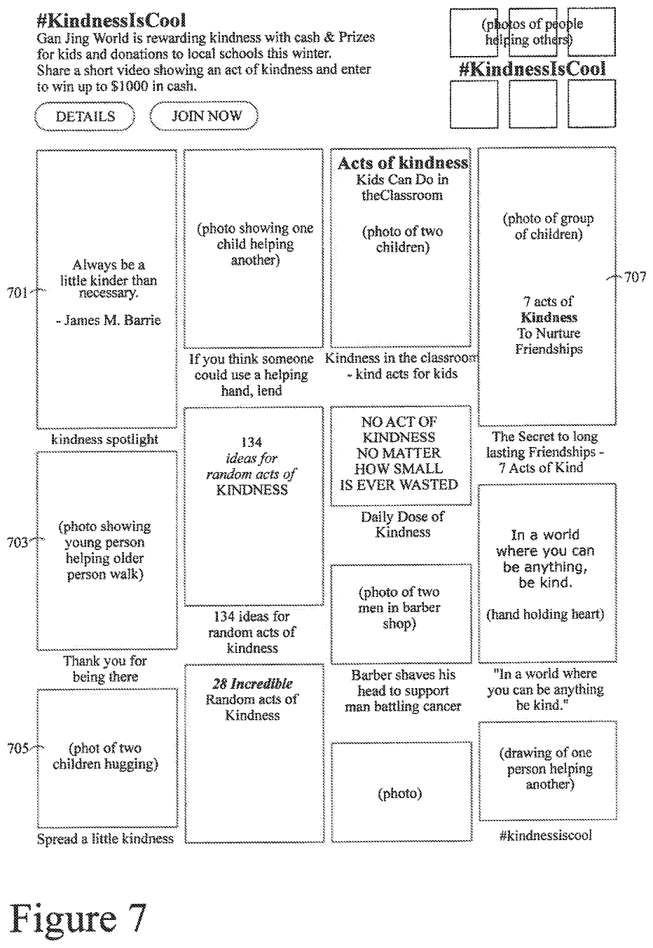

FIG. 7 illustrates a sample aggregation page generated by the Curation and Aggregation software system. For example, the hashtag searched for 701 is displayed at the top of the page. A variety of types of content is displayed including a quote 703, a video 705, and an article 707, for example.

In summary, the Curation and Aggregation Software System of the present disclosure applies an algorithm in the Curation process to segment hashtags with an enhanced processing pipeline and provides multi-layered hashtag analysis on all contents including video, images, and posts to provide, in the Aggregation process, instant semantic lookup of content, based on the hashtag entered, and relationship building, based on the relationships between content determined by the Curation process.

The Curation and Aggregation software system of the present disclosure fosters effective collaboration and synergy among creators and users. Furthermore, administrative access of content aggregations for premium users is provided by the software system so that users can manage content to best suit their needs and best present content to audiences to watch and browse.

For example, the system may include a shopping function for direct selling for businesses. For educators, the system can aggregate educational videos and course materials in one page. Educators could create their own collection by navigating with their chosen hashtags and/or search results to create a collection for sharing purposes. For users and creators, multi-media content can be easily shared or published to other social media platforms according to suitable formats. Creators can create multiple personalized hashtag aggregation pages to engage with their fans and audience; they can organize, manage, and promote content in the aggregation pages.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter and the appended claims.

What is claimed is:

1. A system for curating and aggregating digital content comprising:
a memory having at least one region for storing computer executable program code; and
a processor for executing said program code stored in said memory, wherein said program code comprises:
receiving content uploaded by a first user;
curating said content into a database indexed by hashtags;
upon receiving a request from a second user for a particular hashtag, collecting content from said database indexed by said particular hashtag; and
displaying a listing of said content on an aggregation webpage.

2. The system according to claim 1 wherein said content comprises one or more of text, video files, audio files, photographs, images, podcasts, posts, and any other type of digital content.

3. The system according to claim 1 wherein said curating said content into said database comprises:
breaking down one or more hashtags received with said content into word parts;
creating one or more tags based on said word parts and associating said tags with said content;
storing said content in said database indexed by said one or more hashtags wherein said tags and content type are stored along with said content; and
thereafter using an algorithm to determine a weight for said content and sorting said database according to said weight.

4. The system according to claim 3 wherein said algorithm comprises:
evaluating user engagement metrics for said content to create an engagement score;
analyzing frequency of use for said content to create a frequency score;
evaluating relevance of said content to its hashtags to create a relevance score;
utilizing user data and behavior patterns to determine how close said content is to user preference to create a preference score; and
combining said engagement score, said frequency score, said relevance score, and said preference score to determine said weight.

5. The system according to claim 4 further comprising one or more of the following:
accepting manual input to change said weight; and
accepting input from an artificial intelligence function of said software system to change said weight.

6. The system according to claim 5 wherein any manual input overrides any artificial intelligence input.

7. The system according to claim 3 wherein said collecting content from said database comprises:
for each hashtag entered, retrieving all content from said database indexed by said hashtag and in order as they have been sorted into said database.

8. The system according to claim 7 wherein said displaying a listing of said content comprises:
designing a display layout by categorizing contents of varying dimensions and formats into distinct groups based on predefined page sizes; and
preparing a listing of said contents interleaving them in an alternating arrangement.

9. A non-tangible computer readable storage medium having instructions that when executed by a processor cause said processor to perform operations comprising:
receiving content uploaded by a first user;
curating said content into a database indexed by hashtags;
upon receiving a request from a second user for a particular hashtag, collecting all content from said database indexed by said particular hashtag; and
displaying a listing of said content on an aggregation webpage.

10. The non-tangible computer readable storage medium according to claim 9 wherein said content comprises one or more of text, video files, audio files, photographs, images, podcasts, posts, and any other type of digital content.

11. The non-tangible computer readable storage medium according to claim 9 wherein said curating said content into said database comprises:
breaking down one or more hashtags received with said content into word parts;
creating one or more tags based on said word parts and associating said tags with said content;
storing said content in said database indexed by said one or more hashtags wherein said tags and content type are stored along with said content; and
thereafter using an algorithm to determine a weight for said content and sorting said database according to said weight.

12. The non-tangible computer readable storage medium according to claim 11 wherein said algorithm comprises:
evaluating user engagement metrics for said content to create an engagement score;
analyzing frequency of use for said content to create a frequency score;
evaluating relevance of said content to its hashtags to create a relevance score;
utilizing user data and behavior patterns to determine how close said content is to user preference to create a preference score; and
combining said engagement score, said frequency score, said relevance score, and said preference score to determine said weight.

13. The non-tangible computer readable storage medium according to claim 12 further comprising one or more of the following:
accepting manual input to change said weight; and
accepting input from an artificial intelligence function of said software system to change said weight.

14. The non-tangible computer readable storage medium according to claim 13 wherein any manual input overrides any artificial intelligence input.

15. The non-tangible computer readable storage medium according to claim 12 wherein said collecting content from said database comprises:
for each hashtag entered, retrieving all content from said database indexed by said hashtag and in order as they have been sorted into said database.

16. The non-tangible computer readable storage medium according to claim 15 wherein said displaying a listing of said content comprises:
designing a display layout by categorizing contents of varying dimensions and formats into distinct groups based on predefined page sizes; and
preparing a listing of said contents interleaving them in an alternating content type arrangement.

17. A method for curating and aggregating digital content comprising:
receiving content uploaded by a first user wherein said content includes one or more hashtags and a content type;
curating said content into a database wherein said curating comprises:
breaking down said one or more hashtags received with said content into word parts;
creating one or more tags based on said word parts and associating said tags with said content;
storing said content in said database indexed by said one or more hashtags wherein said tags and content type are stored along with said content; and
thereafter using an algorithm to determine a weight for said content and sorting said database according to said weight; and
upon receiving a request from a second user for a particular hashtag, collecting content from said database indexed by said particular hashtag wherein said collecting content comprises:
for each hashtag entered, retrieving all content from said database indexed by said hashtag and in order as they have been sorted into said database;
thereafter designing a display layout by categorizing contents of varying dimensions and formats into distinct groups based on predefined page sizes and preparing a listing of said contents interleaving them in an alternating arrangement; and
thereafter displaying a listing of said content on an aggregation webpage.

18. The method according to claim 17 wherein said content comprises one or more of text, video files, audio files, photographs, images, podcasts, posts, and any other type of digital content.

19. The system according to claim 17 wherein said algorithm comprises:
evaluating user engagement metrics for said content to create an engagement score;
analyzing frequency of use for said content to create a frequency score;
evaluating relevance of said content to its hashtags to create a relevance score;
utilizing user data and behavior patterns to determine how close said content is to user preference to create a preference score; and
combining said engagement score, said frequency score, said relevance score, and said preference score to determine said weight.

20. The system according to claim 17 further comprising one or more of the following:
accepting manual input to change said weight; and
accepting input from an artificial intelligence function of said software system to change said weight, wherein any manual input overrides any artificial intelligence input.
